(19) United States
(12) Patent Application Publication
(10) Pub. No.: US 2013/0282476 A1
(43) Pub. Date: Oct. 24, 2013

(54) SYSTEM AND METHOD FOR DETERMINING CROSS-CHANNEL, REAL-TIME INSIGHTS FOR CAMPAIGN OPTIMIZATION AND MEASURING MARKETING EFFECTIVENESS

(71) Applicants: Ron Peterson, Playa Vista, CA (US); Ananth Varma, West Hollywood, CA (US)

(72) Inventors: Ron Peterson, Playa Vista, CA (US); Ananth Varma, West Hollywood, CA (US)

(21) Appl. No.: 13/449,425

(22) Filed: Apr. 18, 2012

(51) Int. Cl. G06Q 30/02

(52) U.S. Cl. 705/14.41; 705/14.4

(57) ABSTRACT

The present invention provides a method and system for determining insights for mid-campaign optimization of a marketing campaign and measuring true marketing effectiveness. The method and system includes receiving a plurality of advertising data from one or more advertising data collection sources and electronically processing the advertising data to extract advertising data points therefrom. The method and system include accessing a plurality of historical data points from a historical data point storage device and mapping a plurality of relationships between one or more of the advertising data points and/or the historical data points. Thereupon, the method and system provides for determining at least one advertising campaign modification instruction based on the mapped relationships.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to real-time marketing and management systems and more specifically electronic systems for analyzing and modifying marketing campaigns based on marketing data.

### BACKGROUND OF THE INVENTION

Significant resources are spent by many parties for advertising activities. Those expended resources cover the spectrum from product design, advertising campaign design and subsequent implementation. The growth of the Internet and its continued functionalities provide additional avenues for advertising opportunities, as well as tracking the benefits of such activities.

It is well understood that many existing techniques track advertisement and ad-based activities. For example, common tracking techniques include basic cost-per-click advertising regiments, as well as further sophisticated user tracking activities, e.g. cookies. This data is usable for any number of purposes, including advertiser fees, as well as tracking the effectiveness of an ad campaign.

The explosive growth of personal computing resources provides additional avenues for advertisements, such as for example the usage of social media platforms. It is not uncommon to include social media campaigns as part of a larger advertising campaign, where this provides not only further access to potential customers, but additional levels of feedback for the design and execution of the campaigns themselves. Demographic data can be readily ascertained for social media campaigns, determining the general characteristics of users who indicate a likeness for a particular item. This is also found in web-based advertising where a search engine records not only the selection of an active advertising link, but can correlate demographic and web history information with the user selecting the link.

In evaluating marketing campaigns, marketing directors have access to vast amounts of data to evaluate the success and effectiveness of their marketing campaigns. This data comes from a wide array of suppliers and partner agencies in different formats. Once received, the data often resides with different internal constituents. Suppliers and constituents have different needs and objectives for the data, for example creative agencies are tasked with optimizing creative effectiveness, media agencies are directed to maximize the efficiencies of their media buys, etc. As such, it is difficult for marketing directors to gain holistic oversight in a timely fashion and achieve a thorough analysis of the advertising campaign, especially if it is done after the campaign has been executed.

Part of the media campaign optimization includes various forms of analytical solutions. There are many suppliers of analytical solutions, typically in the form of dashboards that aggregate and display multiple sources of data. These dashboards fail for many reasons including a lack of the full spectrum of data needed for the computational analysis. The data input and output feeds for these analytical engines are limited and thus the engine is unable to perform a completely holistic analysis, including missing proprietary internal or supplier data, such as campaign media spend, creative rotation mix, etc. Product functionality is designed for the broadest possible client base, and therefore, the lowest common denominator, to achieve volume goals. As a result, the output of these solutions are limited by factors pre-determined by the supplier, not the client, and are deficient in terms of evaluative depth while still requiring a high degree of manual involvement.

Another reason existing dashboards fail is that business models and operations of suppliers are structured to sell and service products. These models are not designated to facilitate the process or integrate results into client business practices. Moreover, the existing dashboards provide robust data aggregation and display solutions, but fail to provide any insight and/or recommendations for designing and/or modifying advertising campaigns.

As such, there exists a need for a system and method for determining insight for mid-campaign modification of an advertising campaign and measuring true marketing effectiveness.

### SUMMARY OF THE INVENTION

The present invention provides a method and system for determining insights for mid-campaign optimization of a marketing campaign and measuring true marketing effectiveness. The method and system includes receiving a plurality of advertising data from one or more advertising data collection sources and electronically processing the advertising data to extract advertising data points therefrom. The method and system include accessing a plurality of historical data points from a historical data point storage device and mapping a plurality of relationships between one or more of the advertising data points and/or the historical data points. Thereupon, the method and system provides for determining at least one advertising campaign modification instruction based on the mapped relationships.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of one embodiment of a computer processing system providing for determining insight for advertising campaign modification;

FIG. 2 illustrates a block diagram of one embodiment of a processing system operative to perform the computerized functionality described herein;

FIG. 3 illustrates a flowchart of steps of various embodiments of methods for determining insight for advertising campaign modifications;

FIG. 4 illustrates a sample screen shot of a dashboard display of advertising campaign data including advertising data points; and

FIGS. 5-8 illustrate sample screen shots of dashboard displays and advertising data points from one or more advertising data collection sources.

### DETAILED DESCRIPTION

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

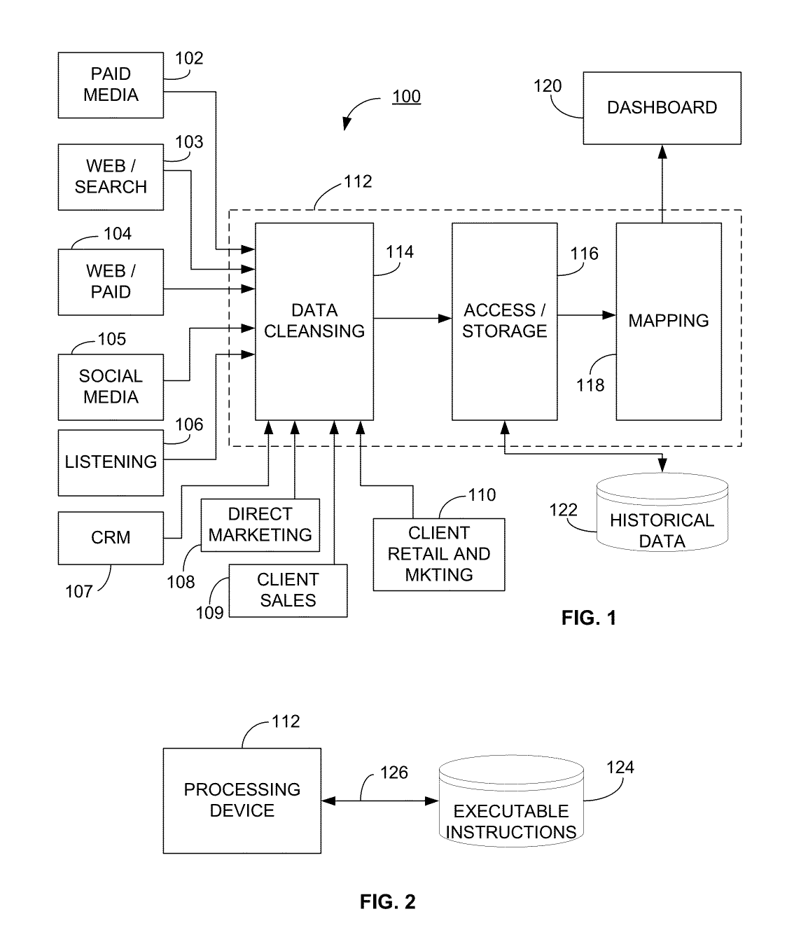

FIG. 1 illustrates a block diagram of a computerized insight system 100 for modifying an advertising campaign. The system 100 includes a plurality of advertising data collection sources including paid media sources 102, website/search engine sources 103, website/page site sources 104, social media sources 105, data monitoring sources 106, customer-relationship management data 107, direct marketing data 108, client sales data 109, and client retail and marketing data 110. The system 100 additionally includes the processing device 112 including a data cleansing device 114, access storage device 116 and a mapping engine 118. The system 100 further includes a dashboard 120 and a historical data database 122.

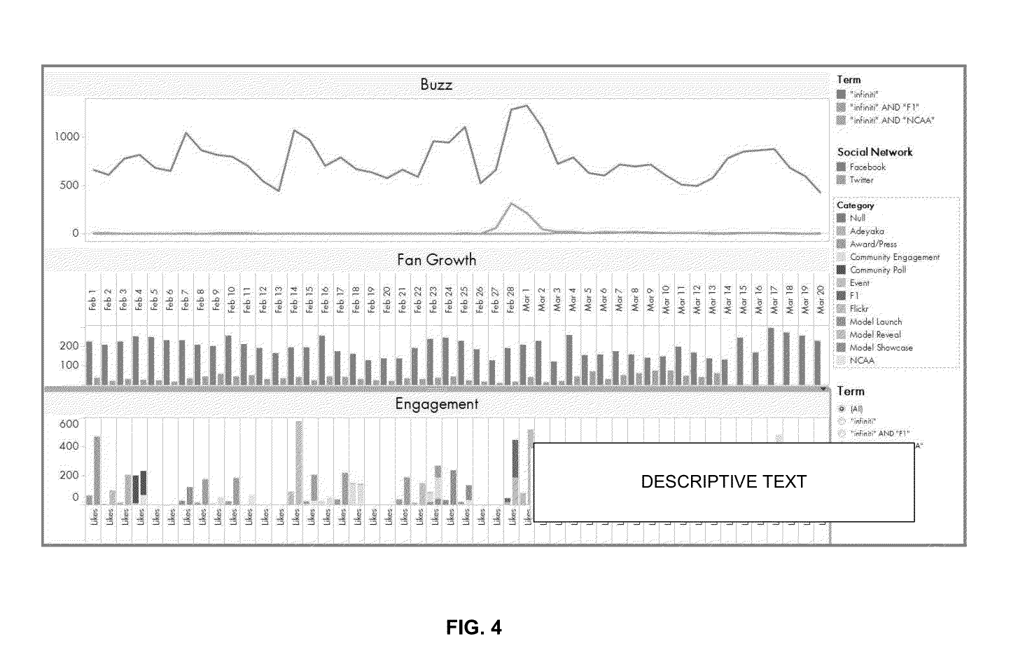

For the sake of brevity, various embodiments of the operation of the system 100 are described with respect to the operational flowchart of FIG. 3.

The paid media data source 102 may be any number of raw data sources including sources providing web service import packages for managing advertising technology. The paid media sources 102 include technology for advertising management and distribution technology for entities seeking advertisement on the web. For example, one exemplary paid media source may be DoubleClick® available from Google®.

The website/search data source 103 may any source that provides data based on web analytics. For example, one exemplary website/search source 103 may be SiteCatalyst® available from Adobe®.

The website/paid data source 104 may be any source that provides data based on analytics of website traffic and marketing effectiveness. The data from this source 106 includes information on the user interactivity of a web site in accordance with known website data acquisition and trafficking data collection techniques. For example, one exemplary website/search source 104 may be Google Analytics® available from Google®.

The social media data source 105 may be any source that provides social media information, including user demographic and content information, as well as user-traffic information. For example, one exemplary social media source 105 may be data available or otherwise acquired from Facebook®.

The listening data source 106 may be any source that actively monitors web or electronic commerce traffic, including brand metric analysis providing market intelligence. For example, one exemplary listening data source 106 may be Nielson Buzzmetrics® available from Nielsen/NetRatings®.

Customer relationship management data 107 may be any source that provides data on existing and potential customers, including but not limited to segmentation of that customer base. For example, one exemplary customer relationship management source may be Salesforce® available from Salesforce.com, Inc.

Direct marketing data 108 may be any channel-agnostic source that is used to communicate straight to the customer, including but not limited to email marketing. For example, exemplary direct marketing data sources may be YesMail® available from Yesmail Interactive.

Client sales data 109 may represent channel-agnostic data that illustrates the business sales of one (or all) sales of a client's products or services. For example, one exemplary client sales data source may be V-Pipe™.

Client retail and marketing data 110 may represent any custom data-source that may be influenced by an advertising campaign, ranging from custom data sets in e-commerce, retail, or B2B operations. For example, one exemplary client retail and marketing data source may be store foot traffic.

Within the processing device 112, the data cleansing device 114 may be one or more processing devices operative to perform data cleansing operations as described in further detail below. The data cleansing device 114 may be a standalone processing component or distributed across one or more platforms to perform the data cleansing operations. In one embodiment, the device 114 operates using a processing device in response to executable instructions.

The access/storage device 116 within the computing system 112 may be one or more processing devices operative to provide data aggregation and database access. As described in further detail below, the device 116 provides functionality for processing cleansed data and accessing historical data, such as using an SQL data access technique. Similar to the device 114, the access/storage device 116 may be a standalone processing component or may be one or more general processing devices performing processing operations in response to executable program code.

The mapping engine 118 may be one or more processing devices operative to perform the mapping operations as described in further detail below. The engine 118 may be one or more processing devices performing operations in response to executable program code, including generation of a dashboard display.

The dashboard 120 of the system 100, in generalized terms, may be an output display such as a video monitor or may be a data feed of output data manipulated for subsequent transmission to a user. Visual feedback is one exemplary feedback mode, whereby the dashboard can provide visual displays as described in further detail below.

The historical data database 122 may be one or more data storage devices having historical data stored thereon. The database 122 may be centrally located or disposed across one or more platforms accessible via electronic communication and communication interface protocols recognized by those skilled in the art. The database 122 allows for read/write access by the processing device 112 as noted below.

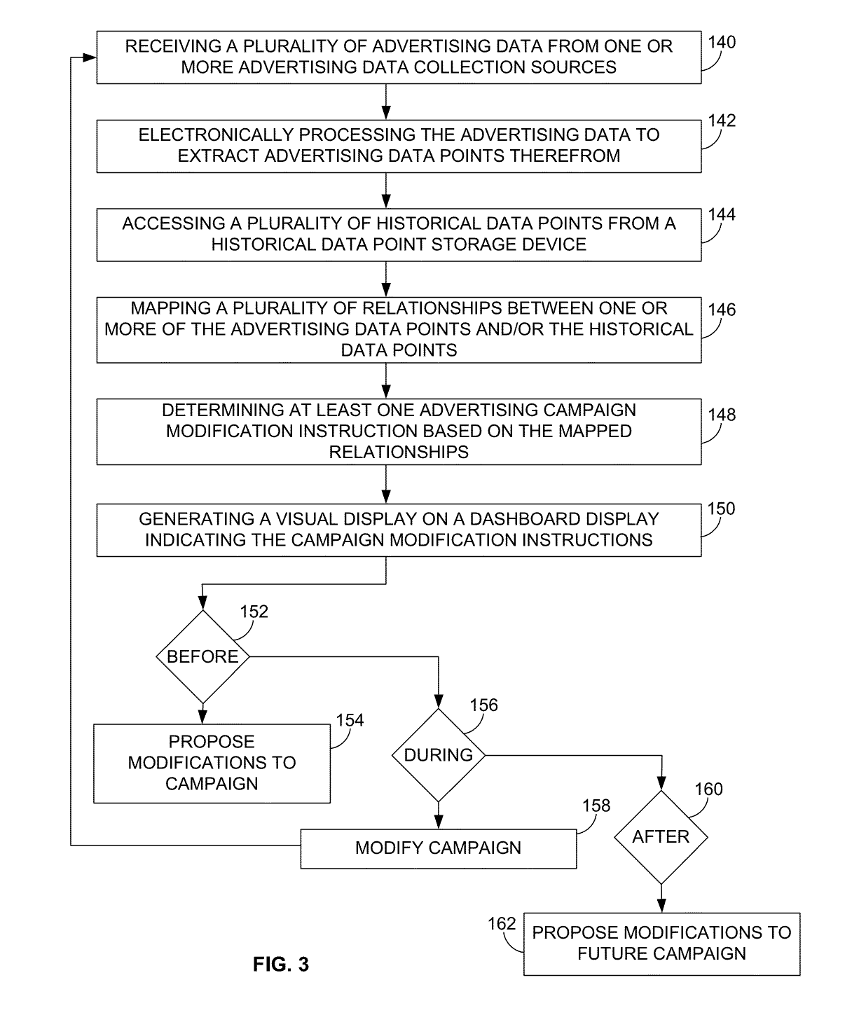

For further clarity, FIG. 2 illustrates one embodiment of the processing device 112 including a computer readable medium 124 having executable instructions 126 stored thereon. The processing device 112 is operative to perform processing operations in response to the executable instructions 126.

FIG. 3 illustrates a flowchart of the steps a method for determining insight modification of advertising campaigns by the system 100 of FIG. 1.

A first step, step 140, is receiving a plurality of advertising data from one or more advertising data collection sources. With respect to FIG. 1, these data collection sources may include one or more of the paid media source 102, website/search source 103, website/paid source 104, social media source 105, listening source 106, customer-relationship management data 107, direct marketing data 108, client sales data 109, and client retail and marketing data 110. (collectively referred to as elements 102-110). The data received from these sources may be in native format generated by the sources themselves. Data is collected from a combination of sources, including using wallscraper technology, measurement tools and analytic sources. Programmed web services import packages and application programming interfaces (APIs) automate the transfer of data from the reporting sources, e.g. 102-110, into the system 112 and subsequently stored in the database 122.

In one embodiment, the processing device 112 may include one or more APIs for communicating with the sources and receiving the appropriate data therefrom. By way of example, if the source is a social media platform 105, an API may be programmed to access campaign data from the platform, including demographic information on users who have selected or viewed advertisements. In another example, if the source is a paid media site 102, the data may be the contracted informational data, such as tracking information on various links, when they were selected, information on the user performing the selection, any demographic information if available, etc.

It is recognized that one or more of the sources 102-110 may represent proprietary data acquired by purchase or engagement of third party vendor to provide the service. Some of the software as a service vendors can provide various amounts of data on different aspects on web-based traffic relating to user-selected topics, in this example being advertising campaigns. They typically do not provide all the data required for complete holistic analysis, specifically proprietary internal or supplier data, such as campaign media spend, creative rotation mix, etc. Product functionality of many of these sources 102-110 is designed for the broadest possible client base, and therefore the lowest common denominator to achieve customer volume goals. As a result, the outputs of these solutions are limited by factors pre-determined by the supplier and not the client, and the raw incoming data from the sources 102-110 are deficient in terms of evaluative depth for provide the desired advertising campaign feedback.

As used herein, advertising data generally refers to any type of data or information acquired, detected, viewed, collected, deduced or otherwise calculated from monitoring marketing activity relating to an advertisement or a collection of advertisements in an advertising campaign.

Step 142 is the electronic processing of the advertising data to extract advertising data points therefrom. Data is passed through cleansing layers that include segmenting the data, identifying relevant data columns, and mapping cross-channel relationships by data source, date, geography, and common analytic metrics. As used herein, advertising data points are discrete data points or data elements extracted from the advertising data, including the data points after extraction of proprietary source data or source-formatting. For example, electronic processing may include data cleansing to extract source data and generate agnostic data elements. By way of example, the raw data from a data source may include formatting and grouping of the data usable for the presentation of the data to the user. By contrast, cleansed data would exclude the formatting and grouping, instead providing the core data including for example, clicks, times of clicks, demographics, host location of clicks, pre-existing processing conditions prior to clicks, effectiveness of clicks including how long or often a user stayed on a subsequent web location, sales and/or leads generation, etc.

With reference back to FIG. 3, a next step, step 144 is accessing a plurality of historical data points from a historical data point storage device. As noted in FIG. 1, the system 100 includes a historical data database 122 accessible by the access/storage device 116. As used herein, historical data points are advertising data points previously acquired, such by data input operations or via previous data cleansing operations by the cleansing device 114. The accessing operation of step 144 may be performed using SQL data access based on advertising campaign parameters defined by a user. The historical data points are acquired from the database 122 for use by the mapping engine 118. The data is centrally aggregated, maintained, and stored in the central repository, which enables cross-correlation as well as serving as a historical repository of user behavior and performance metrics.

Therein, the next step in the embodiment of FIG. 3 is the mapping a plurality of relationships between one or more of the advertising data points and/or historical data points, step 146. The mapping operation may be performed by one or more processing devices in response to executable instructions.

Mapping operations utilize relationships amongst the various data points, whether they are advertising data points recently received from the data cleansing device 114 and/or the historical data points from the historical database 122 of FIG. 1. Mapping may be performed by receiving user criteria relating to an advertisement and/or advertising campaign. By way of example, the criteria may include information of client marketing objectives, business objectives, market type, anticipated consumer demographic, advertising modalities, time and duration of advertisements, costs per placement, click, view, etc. and other criteria.

Based on this criteria, the mapping engine 118 of FIG. 1 is operative to generate the connections between the data points. This mapping of data points generates parameters and feedback regarding advertising decisions. For example, the correlation of various data points may note high volume traffic at various web locations at different times, as well historical data regarding effectiveness of similar advertising campaigns.

A next step, step 148, is determining at least one advertising campaign modification instruction based on the mapped relationships. This step may be performed by processing operations of the mapping engine 118 of FIG. 1, in response to executable instructions. The at least one determination may be based on a comparative operation of the mapping of the data points. For example, one embodiment may include a list of possible campaign modifications and the simulation of these modifications on the mapped data points. Based on these simulations, it may be calculated which modification provides the largest improvement in results and thus be selected.

In another embodiment, modification of an advertising campaign can be in response to user-selected changes, such as designating different media platform for user impressions, e.g. switching to embedded search engine results and sidebar advertising placements on particular search engines compared with pushing electronic mail or community approval through a social media platform. Thus, the dashboard provides visual representation of these proposed or suggested modifications.

In another embodiment, modification of an advertising campaign can be in response to a system-generated alert, that notifies authorized users of abnormal marketing activity, when compared against A) average historical activity or B) predicted trends based off of propensity models or algorithms from the aggregated data. Pre-set conditions may be programmed to automate the advertising campaign modifications based on a pre-set algorithm defined by a criteria set by the user.

A next step, step 150, is generating a visual display of a dashboard display indicating the campaign modification instructions. As illustrated in FIG. 1, the dashboard 120 receives instructional data from the system 112. This instructional data is then usable for generating a visual output of the insight into the advertising campaign. This insight includes the display of modifications to the advertising campaign and visual representations of the resultant differences estimated by the modifications. The resultant differences typically indicate changes in the effectiveness of a campaign, including changes to the number of impressions, clicks, leads, turn-over, revenue generation, etc.

It is recognized that the illustrated steps of the method of FIG. 3 are noted in a particular sequence, but this methodology is not restricted to the noted sequence. By way of example, steps 148 and 150 may be interchanged, including an initial dashboard display prior to the suggested revisions and then an updated dashboard display after the proposed implementation of the suggested campaign modifications, providing near real time interaction with feedback.

The mapping engine 118 and the processing device 112 of FIG. 1 are operative to provide enhanced insight into the modification of advertising campaigns based on not only the historical data points, but also the mapping operations. The insight engine 100 is a recursive operation thus improving each iteration based on further historical data points. The insight engine 100 provides the ability to calculate and propose advertising campaign modifications at any point in any advertising campaign.

With respect to FIG. 3, it is noted that step 152 indicates a decision step if the methodology is occurring before the launch of an advertising campaign. If the analysis by the insight engine 100 is prior to the launch, the methodology includes the step 154 of proposing modifications to the advertising campaign. The insight engine 100 allows for the leveraging of the existing repository of benchmarks, insights and feedback from relevant previous advertising campaigns, such that the engine 100 improves campaign strategy prior to creative and media briefings.

Step 156 indicates the decision step if the methodology is during the advertising campaign. If step 156 is in the affirmative, step 158 provides for modifying campaign. It is noted that the modification of the campaign may be in near real time. There is no limitation or restriction that the steps of FIG. 3 and the operations of the system 100 of FIG. 1 operate on a delayed or defined interval. Rather, the campaign modification may be performed on a near real time, as it is noted the near real time is limited by the data sources 102-110 reporting data and the ability to implement campaign modifications to the advertising channels.

Similarly, step 160 provides that if the methodology of FIG. 3 is performed after the campaign has been executed, step 162 is to propose modifications for future campaigns. Post campaign, the system 100 updates and augments the data repository by including the recently acquired advertising data points. The post campaign processing may further include additional mapping for cross-campaign and cross-client correlations. Moreover, upon completion of an advertising campaign, the advertising data points, as well as any correlations, are stored in the historical database 122.

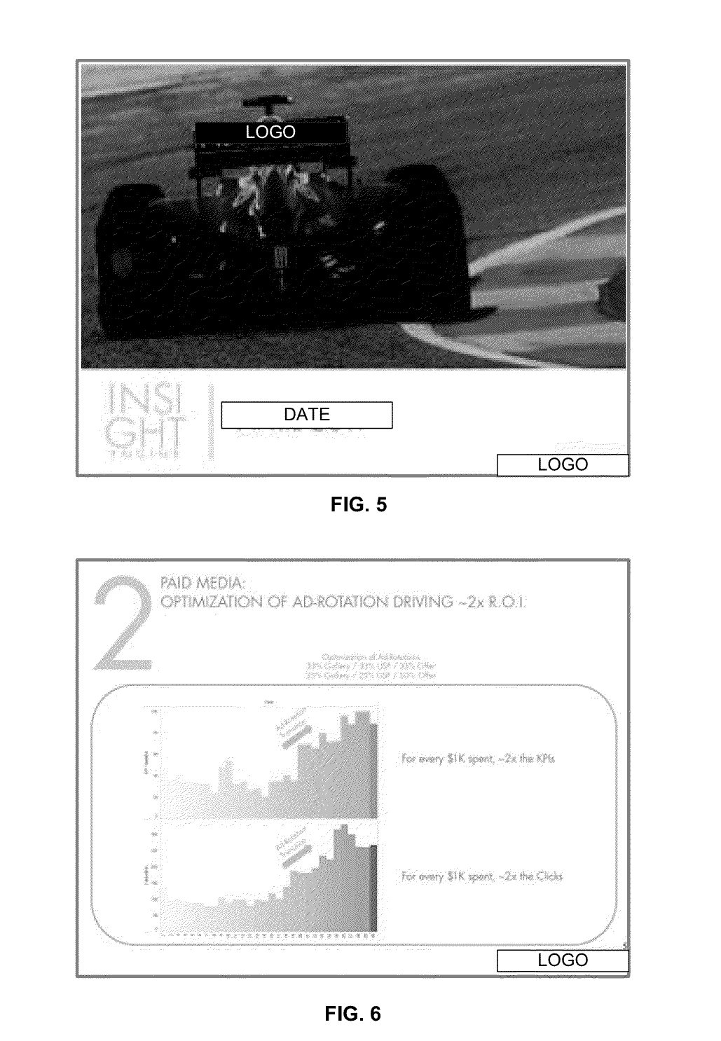

For further reference, FIG. 4 illustrates an exemplary screenshot of a dashboard display. This embodiment illustrates three specific categories usable for advertising campaign insights, buzz, fan growth and engagement. The first display is consumer buzz, illustrating the frequency of the occurrence of various terms found on consumer listening technology (e.g. keyword scraping), in this example being a vehicle manufacturer's name associated with Formula 1 racing and the NCAA basketball tournament. It is visible that the primary manufacturer's name is frequently used, whereas the name in addition to “F1” and “NCAA” has limited occurrences.

A second display on the dashboard is a line graph illustrating fan growth over a period of time based on 2 sample social media sites. In this embodiment, the social media sites are Facebook® and Twitter®. This line graph illustrates the growth of new “fans,” such as by users indicating a likeness on a social media platform, or for example following the account in a messaging service platform.

The third display indicates a social media approval of “like” (or “plus one”) for a particular category. The noted categories in this example include various term and web presence categories, including an online magazine for the manufacturer, awards/press, model information, associations with NCAA basketball tournament, etc.

It is recognized the dashboard of FIG. 4 is illustrative and any number of available displays are readily usable. The data on the dashboard is the visual representation of the advertising data points and historical data points based on the mapping of relationships as described above. Moreover, the dashboard may also be interactive for the adjustment of various factors and readily ascertaining the change in the result, including for example change in dates, change in search terms, social networks, categories, etc.

Similarly, as noted above, the display of the dashboard is usable at all points in an advertising campaign for providing insight for modifications and campaign optimization. The display may be prior to launching a campaign to note historical trends, during a campaign in near real time to track effectiveness and consider possible modifications, and after a campaign to evaluate its effectiveness and garner insight for optimizing future campaigns.

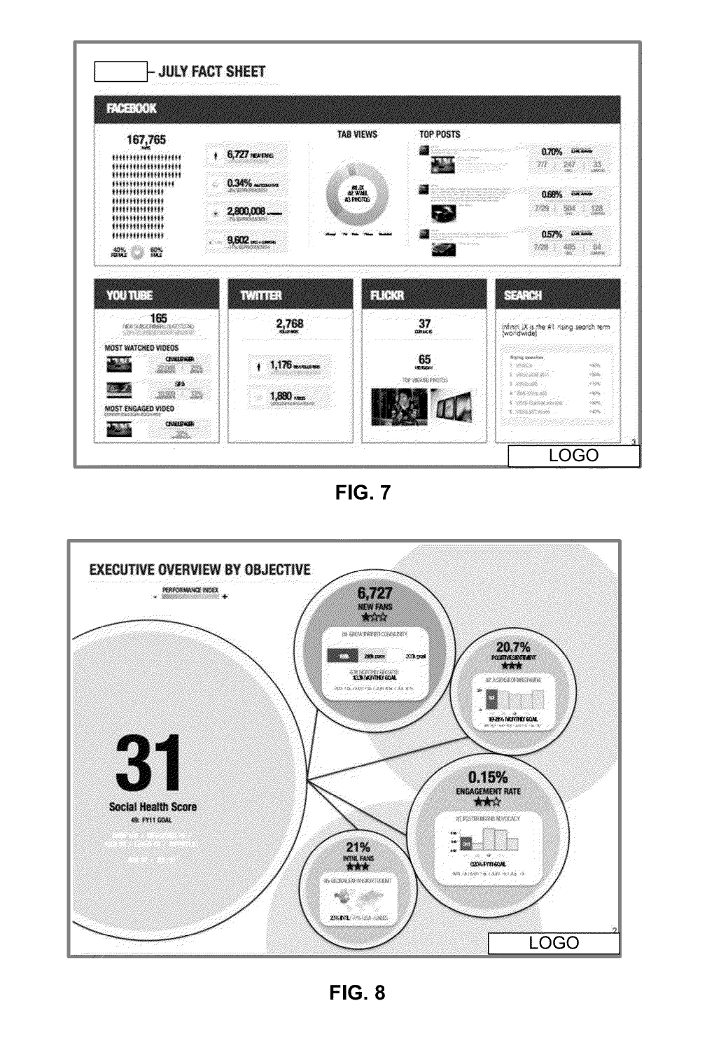

FIG. 5 illustrates an example of an image usable in advertising including a product logo. This figure represents any number of available figures for embedding advertising with different media, this example being a logo with Formula 1 car racing. The dashboard and processing of the insight engine may determine there is a strong correlation with F1 racing for a targeted consumer group, so the image has a high impression value, or by contrast could provide insight of the diminished value, proposing exclusion of the particular image.

FIG. 6 illustrates a sample screen shot of the insight engine applying an analysis of optimization relative to paid media data. In this example, the dashboard illustrates the return on investment for advertising dollars. The graphs, based on the collection and mapping of advertising data, in conjunction with historical data, illustrates that the increase in every one thousand dollars spent, there is approximately 2 times the number of key performance indicators (KPIs) and approximately 2 times the number of user clicks. The dashboard thus processes the advertising and historical data to illustrate the relationship and provide insight for adjustments to the advertising campaign, in this example spending more advertising dollars to see a larger return on investment.

FIG. 7 illustrates another exemplary dashboard screenshot illustrating fact sheets of advertising data points. This exemplary dashboard display breaks down the data points based on source allocations, in this case being web locations of social media, video and image sites and search engines. The exemplary dashboard display shows the advertising data points of the number of social media activities relating to a particular brand and its competitors, advertisement, promotion or similar aspect an advertising campaign. Video and picture data shows the amounts of videos of different videos and pictures and the search illustrates various search terms and other search-related aspects.

Similar to other dashboard displays, this is a snapshot of a data set illustrating multi-platform user interactivity with advertising components based on the advertising data points and historical data points. These dashboard elements are usable for providing insight and suggested modifications to the advertising campaign.

FIG. 8 illustrates another exemplary screenshot of an executive overview. This may be representative of a final review of an advertising campaign, including determining the effectiveness of the campaign. This example illustrates a social health score, being a numerical value representing effectiveness. The score is then translated into distributive components, including social media factors. The various factors can be any number of factors, including the affirmative responses and following of existing and/or new users, as well as tracking the level of engagement of different users. The screenshot of FIG. 8 illustrates one example of a visual representation of the effectiveness of an advertising campaign based on the advertising data points and can also include historical data points. Therefore, a user or the engine 112 of FIG. 1, is able to generate insight into the campaign and perform campaign modifications.

There are additional embodiments for the above-described insight engine including the engine itself being supplier-agnostic. As new channels for advertising and data collection emerge, (e.g., Google+®, Pinterest®, Tumblr®, etc.), the insight engine process remains consistent for aggregating data feeds into a central SQL database, applying a visualization layer, and delivering insights. Whether suppliers modify/update API's or add additional data sources, the underlying process remains fundamentally consistent. Additional data sources may include, but are not limited to: CRM/direct-marketing data, mobile analytics data, additional social media channels, offline metrics, client sales database, qualitative and quantitative 3^{rd} party research, and others.

Another embodiment of the insight engine includes data relating to mobile devices. Mobile applications, tablets, and other devices continue to emerge, and the above-described insight engine is not bound to a singular platform. The reporting layer, including the data cleansing, aggregating and mapping is platform agnostic with dashboard reports delivered and viewed across web, tablet, and mobile devices. Additional computing platforms are envisioned and within the scope of the present invention.

The insight engine and methodology is not limited to a singular vendor or a singular visualization method. Third party visualization software may be used, for example Tableau® software, to aid in this layer. As technology matures, however, it is recognized that additional visualization software, techniques and methodologies may be readily employed.

Moreover, the insight engine creates a repository of holistic data—representing recorded digital ‘clicks’ and consumer behavior patterns recorded throughout time. A benefit to the insight engine process is the ability to leverage this repository of user behavior to create propensity models in the forecasting of future campaigns. Where prior technique projections were often based on self-reported behavior surveys, the insight engine enables accurate modeling based on actual user data. Additional embodiments provide for channel allocation guidance and strategic alert systems relating to the advertising campaigns. These processes allow for greater control of near-real time campaign management.

Another aspect of the insight engine is the aggregation of holistic data. This data is a warehouse of information, sellable for data mining and other service benefits. Leveraging the repository of user-behavior-data, (captured in aggregate across clients and industries), enables the creation of benchmarks and correlation models specific to industry, channel, or platform. Therefore, additional embodiments of the present system and methodology provide for third-party or paid access to the data via the access/storage device 116 for data mining or other data computational operations.

The embodiments of the insight engine described above allow for holistic and near real-time analysis of advertising data. Centralization of all brand/campaign-relevant data allows for optimization against measurements associated with marketing efforts compared with prior solutions involving disaggregation of data inputs across multiple suppliers in disparate formats. Direction integration of data inputs allows for near real-time response to marketing events, e.g launches home page takeovers, asset drops, offline events and/or any other type of marketing event recognized by one skilled in the art. This improves over the limited piecemeal analysis of prior manual advertisement assessment techniques.

The insight engine further provides for full advertising agency integration in the advertisement process. The insight engine allows for coordination with creative, planning, accounting, digital strategy, community management and other areas of the advertising team. The engine also allows for the day to day exposure of the advertising agency to the client management. Thus, by virtue of the insight engine, there is further engagement of the advertisement agency, as well as an increased degree of feedback and coordination between an agency generating and managing an advertising campaign and the client authorizing such campaign.

FIGS. 1 through 8 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A computerized method for determining insight for modification of an advertising campaign and measuring marketing effectiveness, the method comprising:
receiving a plurality of advertising data from one or more advertising data collection sources;
electronically processing, using a computing processing device, the advertising data to extract advertising data points therefrom;
accessing a plurality of historical data points from a historical data point storage device;
mapping a plurality of relationships between one or more of: the advertising data points and the historical data points; and
determining, using the computing processing device, at least one advertising campaign modification instruction based on the mapped relationships.

2. The method of claim 1 further comprising:
generating an output visual display indicating the advertising campaign modification.

3. The method of claim 2, wherein the output visual display is an advertising dashboard display including a visual display of the campaign modifications.

4. The method of claim 1 further comprising:
adding the advertising data points with the historical data points, including storing the advertising data points in the historical data point storage device.

5. The method of claim 1 further comprising:
determining the advertising campaign modification instructions prior to the launch of an advertising campaign, wherein the advertising campaign modification instructions include instructions for launching the advertising campaign.

6. The method of claim 1 further comprising:
determining the advertising campaign modification instructions during the execution of the advertising campaign, wherein the advertising campaign modification instructions include instructions for modifying one or more consumer engagement operations.

7. The method of claim 6, wherein the determining during the execution of the advertising campaign includes determination of advertising campaign modification instructions at regularly defined time intervals.

8. The method of claim 1 further comprising:
determining the advertising campaign modification instructions after the completion of the advertising campaign such that the instructions include suggestions for future campaign optimizations.

9. The method of claim 1, wherein the one or more advertising data collection sources include: media tracking services, search engine analytical engines, social media web locations, web traffic metric services, customer-relationship management data, direct marketing data, client sales data, and client retail and marketing data.

10. A system for determining insight for modification of an advertising campaign, the system comprising:
a computer readable medium having executable instructions stored therein; and
a computer processing device, in response to the executable instructions, operative to:
receive a plurality of advertising data from one or more advertising data collection sources;
process, using a computing processing device, the advertising data to extract advertising data points therefrom;
access a plurality of historical data points from a historical data point storage device;
map a plurality of relationships between one or more of: the advertising data points and the historical data points; and
determine, using the computing processing device, at least one advertising campaign modification instruction based on the mapped relationships.

11. The system of claim 10, wherein the processing device, in response to further executable instructions, is further operative to:
generate an output visual display indicating the advertising campaign modification.

12. The system of claim 11, wherein the output visual display is an advertising dashboard display including a visual display of the campaign modifications.

13. The system of claim 10, wherein the processing device, in response to further executable instructions, is further operative to:
add the advertising data points with the historical data points, including storing the advertising data points in the historical data point storage device.

14. The system of claim 10, wherein the processing device, in response to further executable instructions, is further operative to:
determine the advertising campaign modification instructions prior to the launch of an advertising campaign, wherein the advertising campaign modification instructions include instructions for launching the advertising campaign.

15. The system of claim 10, wherein the processing device, in response to further executable instructions, is further operative to:
determine the advertising campaign modification instructions during the execution of the advertising campaign, wherein the advertising campaign modification instructions include instructions for modifying one or more consumer engagement operations.

16. The apparatus of claim 15, wherein the determining during the execution of the advertising campaign includes determination of advertising campaign modification instructions at regularly defined time intervals.

17. The system of claim 10, wherein the processing device, in response to further executable instructions, is further operative to:
determine the advertising campaign modification instructions after the completion of the advertising campaign such that the instructions include suggestions for future campaign optimizations.

18. The apparatus of claim 10, wherein the one or more advertising data collection sources include: media tracking services, search engine analytical engines, social media web locations, web traffic metric services, customer-relationship management data, direct marketing data, client sales data, and client retail and marketing data.

19. A computer readable medium having executable instructions stored thereon, the executable instructions providing a computerized method for determining insight for modification of an advertising campaign comprising:
receiving a plurality of advertising data from one or more advertising data collection sources;
electronically processing, using a computing processing device, the advertising data to extract advertising data points therefrom;
accessing a plurality of historical data points from a historical data point storage device;
mapping a plurality of relationships between one or more of: the advertising data points and the historical data points; and
determining, using the computing processing device, at least one advertising campaign modification instruction based on the mapped relationships.

20. The computer readable medium of claim 19 including further executable instructions for generate an output visual display indicating the advertising campaign modification.
